(19) United States
(12) Patent Application Publication
(10) Pub. No.: US 2001/0037449 A1
(43) Pub. Date: Nov. 1, 2001

(54) Method for real-time adjustment of processor frequency in a computer system that runs in a windows-type operating environment

(75) Inventors: Jyh-Guang Jou, Chung-Ho City (TW); Honchen Tsau, Chung-Ho City (TW)

Correspondence Address: Finnegan, Henderson, Farabow,, Garrett & Dunner, L.L.P., 1300 I Street, N.W., Washington, DC, 20005-3315, US

(73) Assignee: Micro-Star Int'l Co., Ltd.

(21) Appl. No.: 09/832,883

(22) Filed: Apr. 12, 2001

(30) Foreign Application Priority Data
Apr. 28, 2000 (TW) 089108126

(51) Int. Cl. G06F 1/08

(52) U.S. Cl. 713/100; 713/500

(57) ABSTRACT

In a method for real-time adjustment of an operating frequency of a central processing unit of a computer system that runs in a windows-type operating environment, a windows interface of the computer system is provided with a frequency select unit that is operable so as to select a desired operating frequency for the central processing unit. Then, frequency data corresponding to the desired operating frequency is transmitted to a system management bus controller of a south-bridge chipset of the computer system, and the system management bus controller is enabled to write the frequency data into a timing chipset of the computer system. The timing chipset is subsequently enabled to generate a timing signal corresponding to the frequency data and to provide the timing signal to the central processing unit, thereby enabling the central processing unit to operate at the desired operating frequency.

### BACKGROUND OF THE INVENTION

1. Field of the Invention

The invention relates to a method for real-time adjustment of an operating frequency of a central processing unit (CPU) of a computer system that runs in a Microsoft Windows® operating environment.

2. Description of the Related Art

It has been known heretofore to adjust the operating frequency of a CPU by activating BIOS upon power-on. However, this method involves restarting of the computer system after frequency adjustment, requires the user to have some knowledge of the BIOS, and cannot be performed while the computer system runs in the Microsoft Windows® operating environment.

In another conventional method, jumper settings on the motherboard are varied to adjust the processor frequency. This method, however, can only be conducted when the computer system is turned off, and can only be performed by one who has some knowledge of the computer hardware.

### SUMMARY OF THE INVENTION

Therefore, the main object of the present invention is to provide a method for real-time adjustment of the operating frequency of a central processing unit (CPU) of a computer system that runs in a windows-type operating environment, such as Microsoft Windows®.

According to the present invention, a method for real-time adjustment of an operating frequency of a central processing unit of a computer system that runs in a windows-type operating environment, comprises the steps of:

(a) providing a windows interface of the computer system with a frequency select unit that is operable so as to select a desired operating frequency for the central processing unit;

(b) transmitting frequency data corresponding to the desired operating frequency to a system management bus controller of a south-bridge chipset of the computer system, and enabling the system management bus controller to write the frequency data into a timing chipset of the computer system; and

(c) enabling the timing chipset to generate a timing signal corresponding to the frequency data and to provide the timing signal to the central processing unit, thereby enabling the central processing unit to operate at the desired operating frequency.

### BRIEF DESCRIPTION OF THE DRAWINGS

Other features and advantages of the present invention will become apparent in the following detailed description of the preferred embodiments with reference to the accompanying drawings, of which:

FIG. 1 is a flowchart of the method of the present invention;

FIG. 2 is a flowchart to illustrate how a system management bus controller writes frequency data into a timing chipset in accordance with the first preferred embodiment of the method of this invention;

FIG. 3 is a flowchart to illustrate how the system management bus controller writes the frequency data into the timing chipset in accordance with the second preferred embodiment of the method of this invention; and

FIG. 4 is a flowchart to illustrate how the system management bus controller writes the frequency data into the timing chipset in accordance with the third preferred embodiment of the method of this invention.

### DETAILED DESCRIPTION OF THE PREFERRED EMBODIMENTS

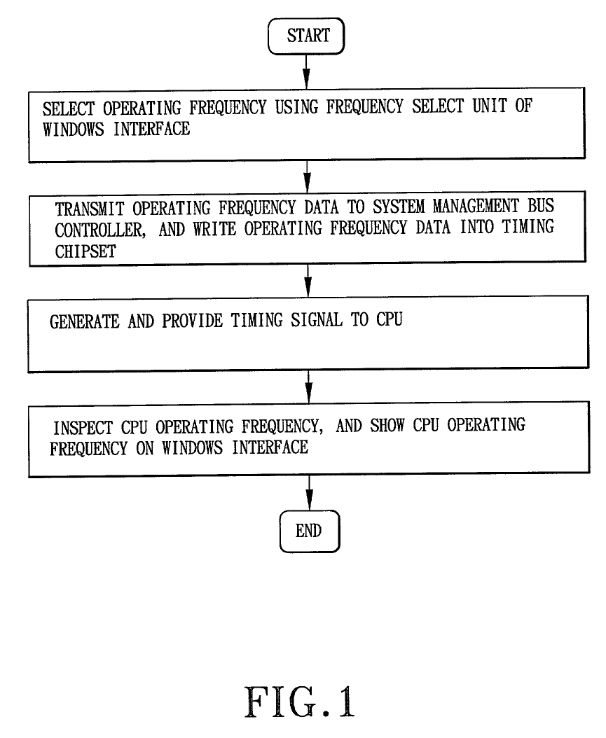

Referring to FIG. 1, the method of this invention is shown to comprise the following steps:

First, a windows interface on a computer monitor is provided with a frequency select unit that is operable so as to enable the user to select a desired operating frequency for a central processing unit of a computer system that runs in a windows-type operating environment, such as Microsoft Windows®. In this embodiment, the frequency select unit is a graphic interface that is set in the windows interface. The frequency select unit is operable to select between two operating modes, i.e. a manual select mode and an automatic select mode.

In the manual select mode, a computer mouse, a computer keyboard or other forms of computer input devices is operated to select the desired operating frequency from a scroll of the frequency select unit. According to the position of a select button on an axis of the scroll, corresponding frequency data is generated and shown on a designated window of the frequency select unit.

In the automatic select mode, the frequency select unit automatically selects an optimum operating frequency that corresponds to current hardware configuration, such as the specification of the CPU that is in use.

Second, upon selection of the desired operating frequency, the frequency data corresponding to the desired operating frequency will be transmitted to a system management bus controller of a south-bridge chipset of the computer system, and the system management bus controller is enabled to write the frequency data into a timing chipset of the computer system.

Third, the timing chipset is enabled to generate a timing signal corresponding to the frequency data that was written therein, and to provide the timing signal to the CPU. The CPU responds by starting to operate at the new operating frequency.

Fourth, the operating frequency of the CPU is inspected, and is shown on the windows interface. More particularly, after the frequency data has been successfully transmitted by the system management bus controller to the timing chipset, the CPU will be enabled to operate at the new operating frequency, and will transmit a numerical value of its new operating frequency to the windows interface so as to give an indication of the same to the user.

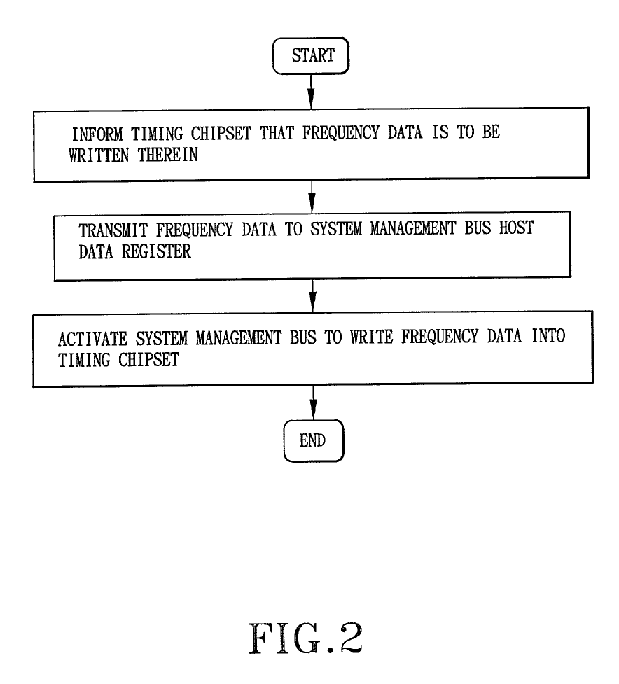

Referring to FIG. 2, in the first preferred embodiment of the method of this invention, the south-bridge chipset is the AMD 756 south-bridge chipset by Advanced Micro Devices. The second step of the method of this embodiment includes the following sub-steps:

1. The timing chipset is informed that the frequency data is to be written therein. Particularly, the address of the timing chipset is set, and the power management bus controller of the south-bridge chipset locates the system management bus base address. The timing chipset address and the system management bus base address are added together, and the result is stored in a host address register.

2. The frequency data is transmitted to a system management bus host data register upon detection that a system management bus of the south-bridge chipset is in a ready state. Particularly, a system management global status register of the system management bus controller is read to determine if the system management bus is in a busy state. If the system management bus is in the ready state, i.e. not in the busy state, the system management bus base address and the system management bus host data offset address are added together to set the system management bus host data register, and the frequency data is transmitted to the system management bus host data register.

3. The system management bus base address and the system management bus host enable offset address are added together to set a system management enable register, and the system management bus is activated to write the frequency data into the timing chipset.

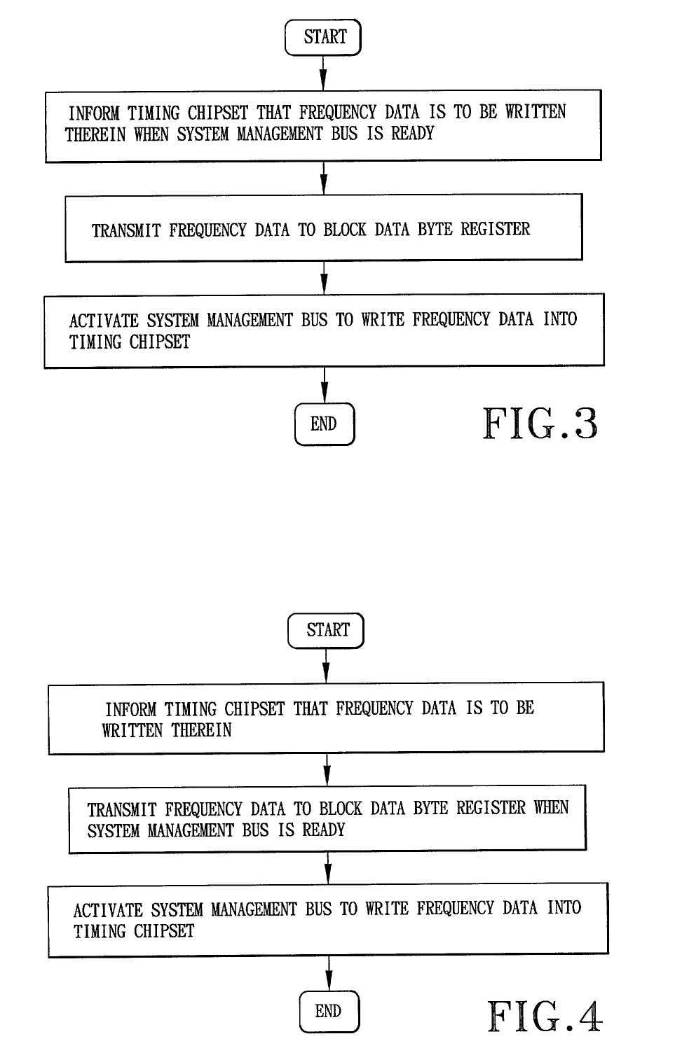

Referring to FIG. 3, in the second preferred embodiment of the method of this invention, the south-bridge chipset is the 82801 AA south-bridge chipset by Intel. The second step of the method of this embodiment includes the following sub-steps:

1. Initially, upon detection that a system management bus of the south-bridge chipset is in a ready state, the timing chipset is informed that the frequency data is to be written therein. Particularly, the power management bus controller of the south-bridge chipset locates the system management bus base address. Then, the system management bus base address and the system management bus host status offset address are added together to determine from the system management bus status register whether the system management bus is in a busy state. If the system management bus is in a ready state, i.e. not in the busy state, the system management bus base address and the timing chipset address are added together, and the result is transmitted to the system management bus slave address register, thereby informing the timing chipset that the frequency data is to be written therein.

2. Then, the frequency data is transmitted in a block format to a block data byte register. More specifically, the system management bus base address and the system management bus host data offset address are added together to set the system management bus data register, so as to obtain the data from the system management bus host control register, and so as to indicate that the data is to be transmitted in a block format. Subsequently, the system management bus base address and the system management bus block data byte offset address are added together so that the data can be transmitted to the block data byte register.

3. The system management bus base address and the system management bus host control offset address are added together to set a system management bus host control register, and the system management bus is activated to transmit the frequency data to the timing chipset.

Referring to FIG. 4, in the third preferred embodiment of the method of this invention, the south-bridge chipset is the VIA 82T686 south-bridge chipset by VIA Technologies Inc. The second step of the method of this embodiment includes the following sub-steps:

1. Initially, the timing chipset is informed that the frequency data is to be written therein. Particularly, the address of the timing chipset is set, and the system management bus base address is located. The timing chipset address and the system management bus base address are added together, and the result is transmitted to a system management bus host address register so as to inform the timing chipset that the frequency data is to be written therein.

2. Then, the frequency data is transmitted in a block format to a block data byte register upon detection that a system management bus of the south-bridge chipset is in a ready state. More specifically, the system management bus base address and the system management bus host offset address are added together for reading the system management bus host status register in order to determine whether the system management bus is in a busy state. If the system management bus is in a ready state, i.e. not in the busy state, the system management bus base address and the system bus host control offset address are added together to set the data of the system management host control register, thus indicating that data is to be transmitted in a block format. Then, the system management bus base address and the system management bus block data byte offset address are added together so that the frequency data can be transmitted to the block data byte register.

3. The system management bus base address and the system management bus host control offset address are added together to set the system management bus host control register, and the system management bus is activated to transmit the frequency data to the timing chipset.

It has thus been shown that the method of this invention permits convenient adjustment of the processor frequency without the need for turning off the computer system and while the computer system runs in the windows-type operating environment, such as Microsoft Windows®.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A method for real-time adjustment of an operating frequency of a central processing unit of a computer system that runs in a windows-type operating environment, comprising the steps of:
(a) providing a windows interface of the computer system with a frequency select unit that is operable so as to select a desired operating frequency for the central processing unit;
(b) transmitting frequency data corresponding to the desired operating frequency to a system management bus controller of a south-bridge chipset of the computer system, and enabling the system management bus controller to write the frequency data into a timing chipset of the computer system; and
(c) enabling the timing chipset to generate a timing signal corresponding to the frequency data and to provide the timing signal to the central processing unit, thereby enabling the central processing unit to operate at the desired operating frequency.

2. The method of claim 1, further comprising the step of:
(d) inspecting the operating frequency of the central processing unit, and showing the operating frequency on the windows interface.

3. The method of claim 1, wherein said step (b) includes the sub-steps of:
informing the timing chipset that the frequency data is to be written therein;
transmitting the frequency data to a system management bus host data register upon detection that a system management bus of the south-bridge chipset is in a ready state; and
activating the system management bus to write the frequency data into the timing chipset.

4. The method of claim 1, wherein said step (b) includes the sub-steps of:
informing the timing chipset that the frequency data is to be written therein after detecting that a system management bus of the south-bridge chipset is in a ready state;
transmitting the frequency data in a block format to a block data byte register; and
activating the system management bus to write the frequency data into the timing chipset.

5. The method of claim 1, wherein said step (b) includes the sub-steps of:
informing the timing chipset that the frequency data is to be written therein;
transmitting the frequency data in a block format to a block data byte register upon detection that a system management bus of the south-bridge chipset is in a ready state; and
activating the system management bus to write the frequency data into the timing chipset.

6. The method of claim 1, wherein the frequency select unit is a graphic interface that is set in the windows interface.

7. The method of claim 6, wherein the frequency select unit is provided with a scroll that is operable using a computer input device to manually select the desired operating frequency.

8. The method of claim 6, wherein the frequency select unit is operable so as to automatically select an optimum operating frequency that serves as the desired operating frequency and that corresponds to hardware configuration of the computer system.
